(19) United States
(12) Patent Application Publication
(10) Pub. No.: US 2008/0008852 A1
(43) Pub. Date: Jan. 10, 2008

(54) Foldable assembly

(76) Inventor: Jackie A. Perry, Onamia, MN (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/818,531

(22) Filed: Jun. 14, 2007

Related U.S. Application Data
(60) Provisional application No. 60/813,415, filed on Jun. 14, 2006.
(60) Provisional application No. 60/832,928, filed on Jul. 24, 2006.

(51) Int. Cl. B32B 3/04

(52) U.S. Cl. 428/77; 229/108.1; 283/106

(57) ABSTRACT

A foldable assembly such as a booklet or pamphlet is disclosed. In embodiments described, the foldable assembly includes a plurality of foldable segments. Each of the foldable segments includes a pair of diagonally foldable sections that are foldable between non-diagonally foldable sections. The foldable segments are unfolded to lay substantially or relatively flat for viewing.

### CROSS-REFERENCE TO RELATED APPLICATION

The present application is based on and claims the benefit of U.S. provisional patent applications, U.S. Ser. No. 60/813,415, filed Jun. 14, 2006 and U.S. Ser. No. 60/832,928 filed Jul. 24, 2006, the content of which is hereby incorporated by reference in its entirety.

### BACKGROUND

The discussion below is merely provided for general background information and is not intended to be used as an aid in determining the scope of the claimed subject matter.

Traditional books or booklets typically include a plurality of sheets that are bound or connected along a single edge. The sheets are connected along a single edge to form a plurality of pages of the book or booklet. Since multiple sheets are bound along a single edge, a user must flip multiple sheets in order to view the content of each page of the book or booklet.

### SUMMARY

The Summary and Abstract are provided to introduce a selection of concepts in a simplified form that are further described below in the Detailed Description. The Summary and Abstract are not intended to identify key features or essential features of the claimed subject matter, nor are they intended to be used as an aid in determining the scope of the claimed subject matter. In addition, the claimed subject matter is not limited to implementations that solve any or all disadvantages noted in the background.

As described, the present invention provides a foldable assembly, such as a booklet or pamphlet. In embodiments described, the foldable assembly includes a plurality of foldable segments. Each of the foldable segments includes a pair of diagonally foldable sections that are foldable between non-diagonally foldable sections. The foldable segments are unfolded to lay substantially or relatively flat for viewing. The application relates to these and other features or advantages as disclosed in the detailed description herein.

### BRIEF DESCRIPTION OF THE DRAWINGS

FIG. 1 is a top view of an embodiment of a foldable assembly folded and closed using elastic closures.

FIGS. 2-3 illustrate the foldable assembly of FIG. 1 being opened or unfolded.

FIG. 4 is a top view of a foldable sheet shown un folded or flat.

FIG. 5 is a lower view of the foldable sheet of FIG. 4 shown unfolded or flat.

FIG. 6 is a side view of the foldable sheet of FIGS. 4-5, shown partially folded or relatively flat.

FIG. 7 illustrates a foldable sheet having a pocket formed on one of the non-diagonally foldable sections of the foldable sheet.

FIG. 8 is a sectional view taken along line 8-8 of FIG. 7.

### DETAILED DESCRIPTION OF ILLUSTRATIVE EMBODIMENTS

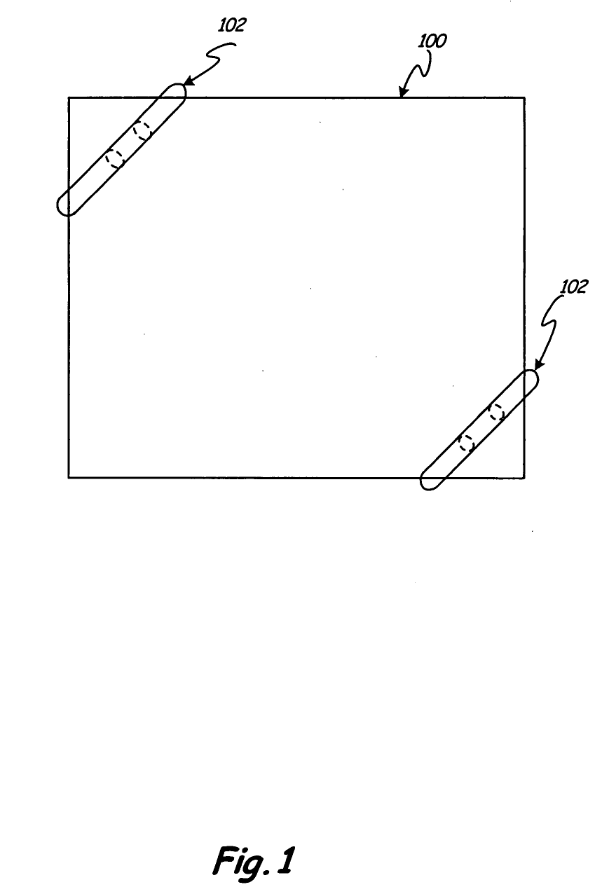

FIG. 1 illustrates a foldable assembly 100, such as a book, pamphlet or packet that is shown folded. In the illustrated embodiment, the foldable assembly 100 is secured in a foldable position by elastic closures 102 so that the assembly 100 remains folded until the elastic closures 102 are removed. Although two elastic closures 102 are shown, application is not limited to the number and placement of the elastic closures 102 shown.

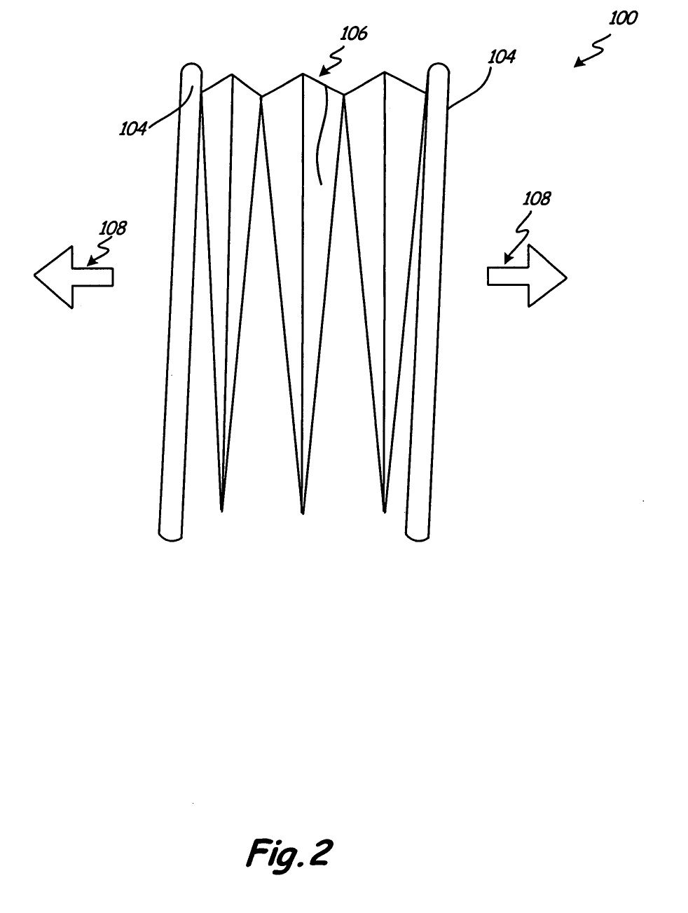

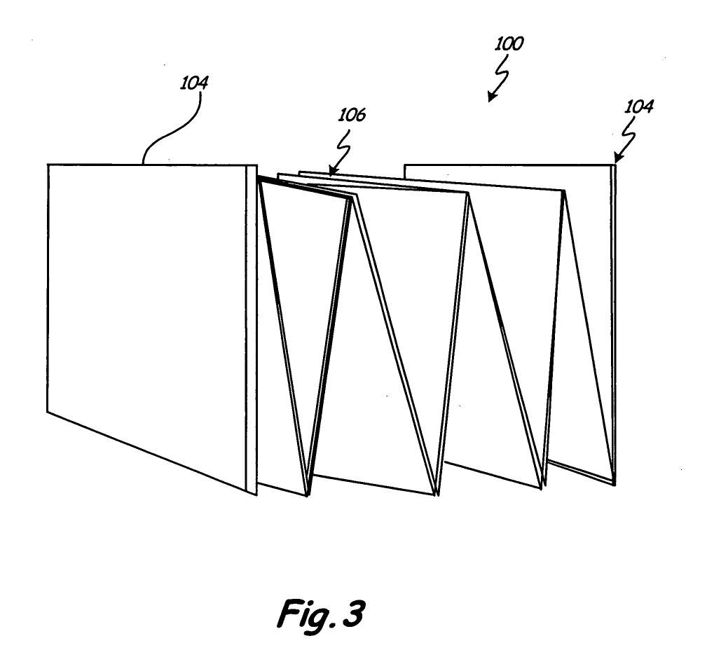

In one embodiment, the foldable assembly 100 includes opposed covers or ends 104 and a foldable sheet 106 disposed between the opposed covers or ends 104. As progressively illustrated in FIGS. 2-3, the assembly is opened by separating the covers 104 (as illustrated by arrows 108 in FIG. 2) to unfold the 106 sheet for display or viewing. The assembly is collapsed by moving the covers or ends 104 toward each other and folding or collapsing the foldable sheet 106. In an illustrated embodiment the covers or ends 104 are formed of a relatively stiff cardboard material and the foldable sheet 106 is formed of a paper or other thin foldable material. In the illustrated embodiment, the covers or ends 104 are glued to the foldable sheet 106 to form the foldable assembly 100. In alternate embodiments, covers or ends can be integral with the foldable sheet 106.

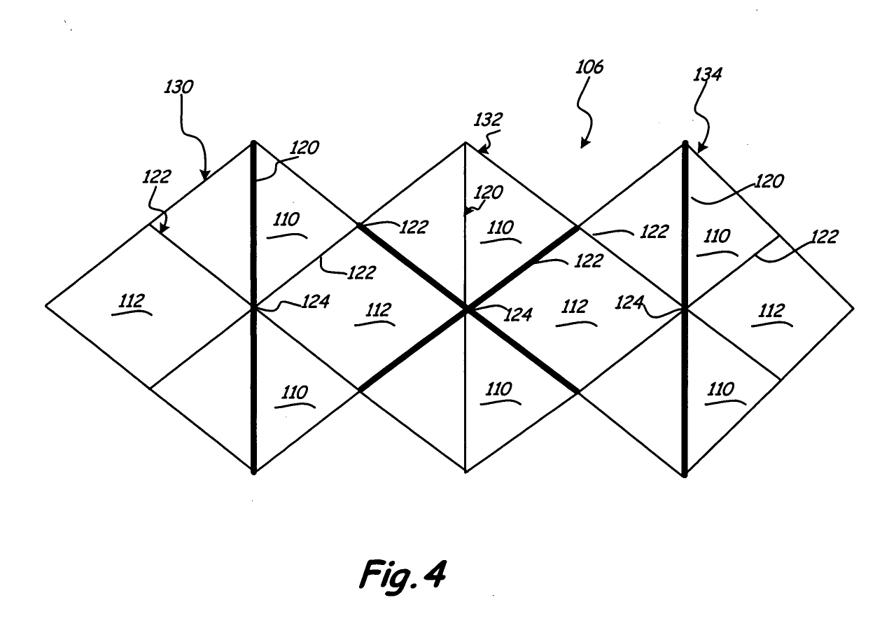

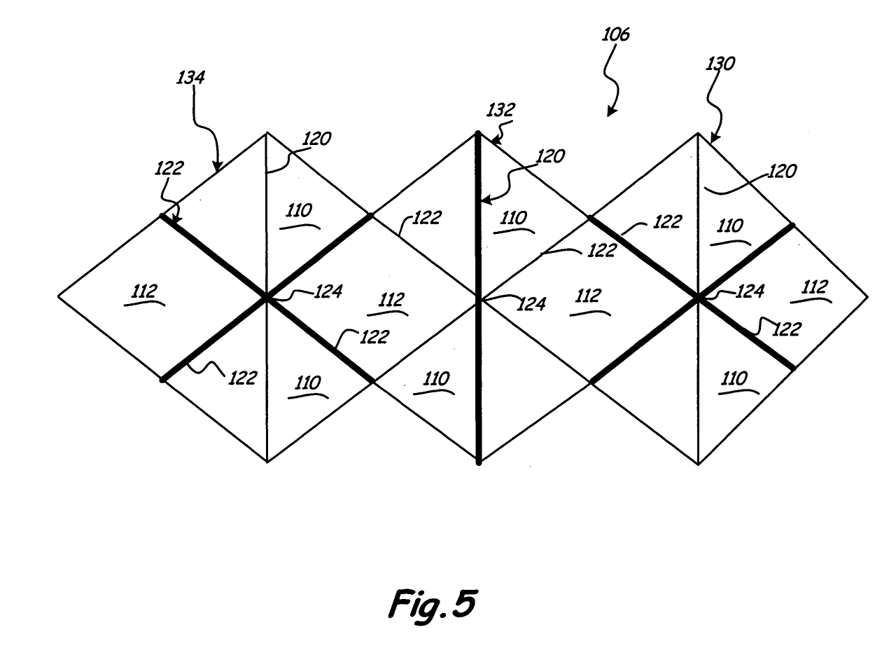

FIGS. 4-5 illustrate the foldable sheet 106 illustrated in FIGS. 2-3 unfolded. The foldable sheet 106 can be unfolded to lay substantially flat. As shown, the foldable sheet 106 includes diagonally foldable sections 110 and square or non-diagonally foldable sections 112. Pairs of diagonally foldable sections 110 and square sections 112 are folded along diagonal fold lines 120 and section fold lines 122 relative to a center apex 124. The foldable sheet as shown includes a plurality of diagonally foldable section pairs that fold relative to a plurality of center apexes 124 along a length of the foldable sheet 106. In the illustrated embodiment, the plurality of diagonally foldable section pairs alternate fold directions to form a plurality of fold segments 130, 132, 134 along the length of the foldable sheet 106. In the illustrated embodiment, segments 130, 134 have one fold direction and segment 132 has a second or alternate fold direction.

FIGS. 4-5 illustrate a fold pattern of the foldable sheet 106 to provide multi-direction foldable segment 130, 132, 134. As shown in FIG. 4, the diagonal fold lines 120 of segments 130, 134 are top or obverse folded (illustrated by thicker line segments). The section fold lines 122 of segment 132 are also top or obverse folded (illustrated by thinner line segments). In contrast, as illustrated in FIG. 5, the diagonal fold line 120 of segment 132 and the section fold lines 122 of segments 130 and 134 are bottom or reversed folded to provide alternating fold directions for segments 130, 134 and segment 132. In an illustrative embodiment, the sheet 106 is die cut in a profile as generally illustrated in FIGS. 4-5. The fold lines 120 and 122 are formed by die creases.

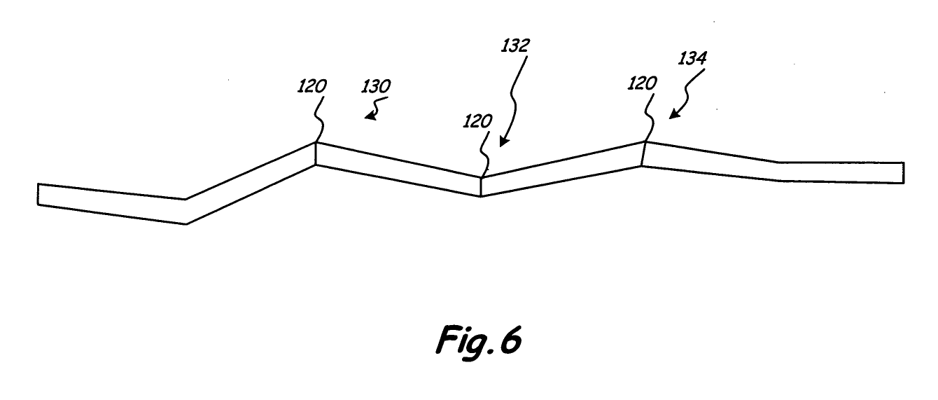

FIG. 6 illustrates a foldable sheet partially folded or relatively flat to illustrate the alternating fold directions for segment 130, 132, 134 as previously described. Thus, as described, the foldable sheet 106 is folded for storage and is opened or unfolded for use. Sections 110 and 112 of the sheet 106 can be printed or include text or illustrations or alternatively can be blank. The sheet 106 can be colored or white and application is not limited to the specific number of folds or segments shown. As previously described, the sheet 106 can be attached to covers or ends 104 to form a stiffer structure, although application is not limited to attachment of the sheet 106 to separate covers or ends 104 as shown in FIG. 2.

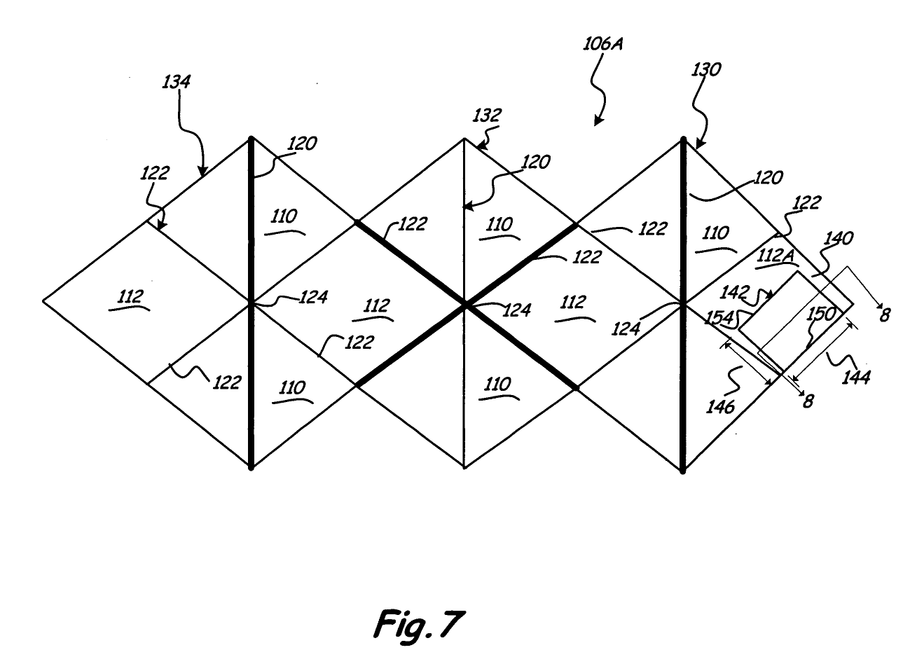

FIG. 7 illustrates an alternate embodiment of a foldable sheet 106A where like numbers are used to identify like parts in the previous FIGS. In the embodiment shown, the foldable sheet 106A includes segments 130, 132, 134 including a pair of diagonally foldable sections 110 and non-diagonally foldable sections 112. In the embodiment shown, segment 134 includes a pocket 140 formed on non-diagonally foldable section 112A which, forms an outer edge of the foldable sheet 106A. The pocket 140 includes an opening 142 sized to insert a credit card or other item into the pocket 140. In the illustrated embodiment shown in FIG. 7, the pocket has a length 144 and height 146 sized for insertion of a credit card, bank card or other magnetic card or storage device. Although a particular size and shape is shown, the pocket 140 can have alternate sizes or shapes depending upon the particular use or item that is inserted into the pocket.

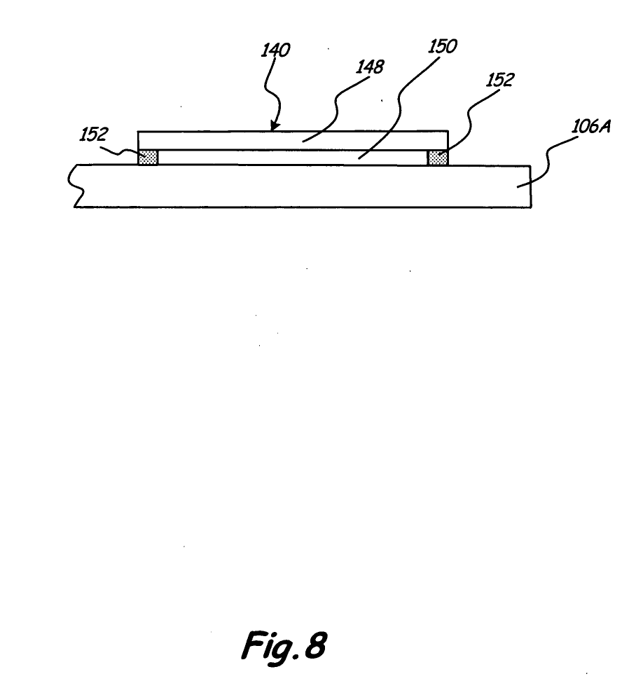

FIG. 8 is a cross-sectional view illustrating the pocket 140 of FIG. 7. As shown, the pocket 140 includes an upper sheet 148 that is connected to the foldable sheet 106A (e.g. section 112A) along an end seam 150 and opposed side seams 152 connecting the upper sheet 148 to the foldable sheet 106A. The upper sheet 148 is not connected to the foldable sheet along edge 154 (shown in FIG. 7) to form the opening 142 for the pocket 140. In an illustrative embodiment, upper sheet 148 of the pocket 140 is formed of a transparent sheet or material so that a credit card or other item inserted into the pocket 140 is visible when the foldable sheet 106A is opened or unfolded.

Although FIG. 7 illustrates the pocket 140 connected to non-diagonally foldable section 112A, application is not limited to the specific placement shown and the pocket 140 can be formed to alternate sections 112 or alternately connected to a sheet 106 having an alternate fold pattern for segments 130, 132, 134. For example, the pocket 140 can be connected to a section having top or obverse section fold lines in contrast to the bottom or reversed fold lines of section 112A shown

Although the present invention has been described with reference to preferred embodiments, workers skilled in the art will recognize that changes may be made in form and detail without departing from the spirit and scope of the invention. Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims.

What is claimed is:

1. A foldable assembly comprising:
a foldable sheet comprising at least two pairs of diagonally foldable sections that are foldable between non-diagonally foldable sections.

2. The foldable assembly of claim 1 wherein the at least two pairs of diagonally foldable sections are foldable along a diagonal fold line and section fold lines.

3. The foldable assembly of claim 1 wherein the at least two pairs of diagonally foldable sections include a first pair of diagonally foldable sections having a first fold direction and a second pair of diagonally foldable sections having a second fold direction different from the first fold direction.

4. The foldable assembly of claim 1 wherein the foldable assembly includes at least one elastic closure coupled to the foldable sheet.

5. The foldable assembly of claim 1 wherein the foldable assembly includes end covers coupled to the foldable sheet.

6. A method comprising:
forming a first foldable segment including a plurality of diagonally foldable sections foldable between non-diagonally foldable sections; and
forming a second foldable segment including a plurality of diagonally foldable sections foldable between non-diagonally foldable sections.

7. The method of claim 6 and comprising:
using die creasing to form the diagonally foldable sections and the non-diagonally foldable sections of the first and second foldable segments.

8. A foldable assembly comprising:
a foldable sheet including at least one pair of diagonally foldable sections that is foldable between non-diagonally foldable sections; and
a pocket coupled to at least one of the non-diagonally foldable sections.
